(19) United States
(12) Patent Application Publication
(10) Pub. No.: US 2026/0355835 A1
(43) Pub. Date: Nov. 12, 2026

(54) MACHINE TOOL WITH PIVOTABLE CENTRING SENSOR

(71) Applicant: REISHAUER AG, Wallisellen (CH)

(72) Inventors: Erwin SENNHAUSER, Kleinandelfingen (CH); Patrizia KWAK, Fällanden (CH)

(73) Assignee: REISHAUER AG, Wallisellen (CH)

(21) Appl. No.: 19/514,980

(22) PCT Filed: Sep. 4, 2024
(86) PCT No.: PCT/EP2024/074637

§ 371 Date: Feb. 27, 2026

(30) Foreign Application Priority Data
Sep. 7, 2023 (CH) CH000976/2023

(51) Int. Cl. B23F 23/12; B23F 1/02

(52) U.S. Cl. CPC B23F 23/1218; B23F 1/023

(57) ABSTRACT

A machine tool for machining pre-toothed workpieces including a tool carrier, on which a tool spindle is arranged for rotationally driving a machining tool about a tool spindle axis, a workpiece carrier, on which a workpiece spindle is arranged for rotationally driving a pre-toothed workpiece to be machined about a workpiece spindle axis, a first non-contacting meshing probe, configured to determine a phase position of teeth of the workpiece when the workpiece rotates about the workpiece spindle axis, and a swivel device. The swivel device includes a swivelable probe carrier to which the first meshing probe is attached to swivel the first meshing probe between a measuring position and a parking position. The swivel device is arranged on the tool carrier, and the swivel device is configured to swivel the first meshing probe about the tool spindle axis.

### TECHNICAL FIELD

The present invention relates to a machine tool for machining pre-toothed workpieces, which comprises a meshing probe and a swivel device for swiveling the meshing probe.

### PRIOR ART

When fine machining pre-toothed workpieces, the tool and the workpiece to be machined must be aligned with respect to each other before each machining operation so that the tool can enter the tooth space of the workpiece without collision. This procedure is known in the trade as “meshing”.

This type of meshing is particularly necessary for continuous generating machining processes. In such processes, the workpiece to be machined is brought into engagement with a worm-shaped tool and machined in gear coupling with the tool. In modern, numerically controlled (NC) gear manufacturing machines, the workpiece is clamped on a numerically controlled (NC), rotary-driven workpiece spindle. The tool is clamped on a tool spindle, which is also numerically controlled and driven to rotate. The gear coupling between the tool spindle and the workpiece spindle is then established electronically by the NC. Precise knowledge of the position of the tooth spaces of the workpiece to be machined is also required for processes other than generating machining, e.g. profile grinding.

Non-contacting meshing probes are usually used for meshing, which work on an inductive or capacitive basis and determine the position of the tooth flanks while the workpiece is rotating. The gear coupling angle is determined electronically on the basis of such a non-contact measurement.

Other checks may also be carried out using the phase position of the signals of all teeth over one workpiece rotation. For example, a check for pre-machining errors and concentricity deviations may be made, a pitch measurement may be carried out to determine the tooth pitch, and the tooth gap width may be used to estimate the existing stock allowance. In addition, the helix direction may be determined using the machine axes and/or the helix angle may be measured on the workpiece.

To measure the position of the tooth flanks, the meshing probe is usually brought into a measuring position in which the meshing probe is close to the workpiece. During subsequent machining of the workpiece with a machining tool, however, the meshing probe should be protected from collisions and contamination as best as possible.

It is therefore known to move the meshing probe back and forth between a measuring position and a parking position by means of a displaceable or swivelable device.

DE20218352 U1 discloses, for example, a device which has a measuring probe which is arranged on a holder designed as a kinematic member of an articulated link parallelogram, in which the member opposite the holder is rigidly connected to the machine stand or the housing of the workpiece spindle.

DE 19928500 A1 discloses a CNC tooth flank grinding machine which has a spindle that can be moved in parallel to the workpiece axis, the spindle being attached to the machine bed next to the workpiece spindle and having a spindle axis that runs in parallel to the workpiece axis. At the upper end of the spindle there is a measuring probe holder which can be swiveled about said spindle axis.

WO 2017/194251 A1 discloses a generating grinding machine in which a meshing probe device is axially and/or radially displaceable relative to the workpiece axis by means of an adjusting drive arranged on the counter-stand of the workpiece carrier.

However, such arrangements, in which the meshing probe device is located directly on the workpiece carrier or close to it, can hinder freedom of movement when clamping/removing the workpiece from the workpiece spindle and, especially when using automatic workpiece changers, pose a risk of collision.

### SUMMARY OF THE INVENTION

It is therefore an object of the present invention to provide a machine tool for machining pre-toothed workpieces with a non-contact meshing probe, in which the meshing probe is exposed to low collision risks during workpiece change and yet an efficient and precise meshing operation is made possible.

The task is solved by a machine tool with the features of claim 1. Further embodiments are given in the dependent claims.

A machine tool for machining pre-toothed workpieces is thus provided, comprising:
a tool carrier on which a tool spindle is arranged for rotationally driving a machining tool about a tool spindle axis;
a workpiece carrier on which a workpiece spindle is arranged for rotationally driving a pre-toothed workpiece to be machined about a workpiece spindle axis,
a first non-contacting meshing probe which is configured to determine a phase position of teeth of the workpiece when the workpiece rotates about the workpiece spindle axis, and
a swivel device, wherein the swivel device comprises a probe carrier that can be swiveled, to which the first meshing probe is attached in order to swivel the first meshing probe between a measuring position and a parking position.

The swivel device is arranged on the tool carrier and is configured to swivel the first meshing probe around the tool spindle axis.

By arranging the swivel device on the tool carrier, the risk of accidentally damaging the meshing probe when handling the workpiece spindle is low. In addition, the range of movement around the workpiece spindle is increased compared to arrangements in which the meshing device is arranged on the workpiece carrier, which simplifies the use of an automated workpiece changer, for example. As the swivel device is configured to swivel the meshing probe around the tool spindle axis, a particularly compact arrangement is additionally enabled.

The machine tool may in particular be a generating grinding machine for continuous generating gear grinding of the pre-toothed workpieces, whereby the machining tool may in particular be a worm-shaped profiled grinding wheel, i.e. a grinding worm.

The machine tool may comprise a large number of moving components, such as slides or spindles, which may be moved in a controlled manner by corresponding drives. The control is preferably carried out digitally by a computer. These drives are often referred to as “NC axes”, “machine axes” or shortened to “axes”. In some cases, these terms also encompass the components driven by the drives, such as slides or spindles. In the present context, however, the term “axis” is used in the geometric sense and therefore includes neither the drives nor the driven components.

The tool carrier and the workpiece carrier are moveable relative to each other. In particular, the tool carrier is preferably displaceable relative to the workpiece carrier in an infeed direction perpendicularly and in particular radially to the workpiece spindle axis, whereby a radial position of the machining tool and the meshing probe can be changed relative to the pre-toothed workpiece. The machine tool comprises an axial slide guided on the tool carrier, which is displaceable relative to the workpiece carrier in an axial direction parallel to the workpiece spindle axis, as well as a shift slide, which is arranged on the axial slide. The tool spindle and the swivel device are arranged on the shift slide. By moving the axial slide, the axial position of the machining tool and the meshing probe relative to the pre-toothed workpiece can be changed. The shift slide is displaceable parallel to the tool spindle axis relative to the workpiece carrier, whereby a tangential position of the machining tool and the meshing probe can be changed relative to the pre-toothed workpiece. The shift slide may also be swivelable about a swivel axis running in parallel to the infeed direction, whereby an axis intersection angle between the tool spindle axis and the workpiece spindle axis can be changed in order to be able to adapt to a helix angle of the pre-toothed workpiece to be machined. For this purpose, the shift slide may be arranged so as to be linearly displaceable on a swivel body, which in turn is arranged in a swivelable manner on the axial slide.

A second workpiece spindle may also be arranged on the workpiece carrier, wherein the workpiece carrier may be rotatably mounted in order to be able to rotate either the first workpiece spindle or the second workpiece spindle into a machining position, while the machined workpiece can be unloaded or a new workpiece can be clamped on the workpiece spindle that is not in the machining position.

As the same slides and drives can be used to position the meshing probe as can be used to move or swivel the tool spindle with the machining tool clamped thereon in the aforementioned directions, there is great flexibility in positioning the meshing probe relative to the workpiece without the need for additional drives. This makes it possible to adapt to workpieces with different diameters and/or different widths of the toothing and/or different positions of the toothing along the workpiece axis or to workpieces with multiple toothing. Moreover, the structure of the machine tool is kept compact by using the above-mentioned drives and slides.

Non-contacting meshing probes may for example be based on an inductive, capacitive or optical measuring principle. The meshing probe defines a probe axis which corresponds to a measuring direction of the meshing probe. In particular, the meshing probe may be configured to output a measurement signal, with each meshing probe having a probe-specific measuring range. If material enters the measuring range, the measurement signal changes. Viewed along the probe axis, the meshing probe can have a maximum measuring distance: material that is further away along the probe axis than the maximum measuring distance is not detected by the meshing probe and therefore does not cause a signal change. The measurement signal may be analog or digital. In particular, the measurement signal may be a binary switching signal that indicates whether material is within the measuring range: if yes, the binary switching signal assumes a first value, preferably a logical one, if no, the binary switching signal assumes a second value, preferably a logical zero. However, the measurement signal may also be an essentially continuous measurement signal, the value of which may be a measure for a distance of the meshing probe from the material or for the amount of material in the measurement range.

The machine tool may also comprise a second non-contacting meshing probe, which is configured to determine a phase position of the teeth of the workpiece when the workpiece rotates around the workpiece spindle axis, wherein the second meshing probe is also mounted on the probe carrier. The first meshing probe and the second meshing probe may in particular be arranged next to each other inparallel to the tool spindle axis on the probe carrier.

The use of a second meshing probe may be particularly helpful for meshing operations on workpieces that have a double gear.

In particular, the use of a second meshing probe can be useful if the double gear workpiece has a first gear with a module that differs from the module of the second gear of the double gear workpiece. In the present context, the module is defined as the pitch circle diameter of the gear divided by the number of teeth of the gear. In order to obtain a meaningful measurement, the meshing probe used should have a measuring range that is adapted to the module of the gear to be measured. If the measuring range of the meshing probe is too large compared to the module of the gear, this may lead to an unusable output signal from the meshing probe, as the meshing probe can no longer detect the tooth gaps as such (since the meshing probe always detects material). If, on the other hand, the measuring range of the meshing probe is too small compared to the module of the gear, the output signal of the meshing probe may be distorted, as the measuring range does not reach deeply enough into the tooth gaps and therefore unwanted sections of the teeth are detected.

The first meshing probe therefore preferably has a first measuring range that is specified for a first module range. When the machine tool is used, the module of the first gear of the double gear workpiece should then be in this first module range.

If the module of the second gear of the double gear workpiece lies outside this first module range of the first meshing probe, the use of a second meshing probe with a correspondingly larger or smaller second measuring range may therefore be particularly helpful.

The second meshing probe therefore preferably has a second measuring range, which is specified for a second module range that differs from the first module range. When the machine tool is used, the module of the second gear of the double gear workpiece should then be located in the second module range.

A meshing operation for a double gear workpiece may have the following steps:
positioning the first meshing probe in a first measuring position to measure the first gear with the first meshing probe;
determining the phase position of the tooth flanks of the first gear with the first meshing probe;
positioning the second meshing probe in a second measuring position to measure the second gear with the second meshing probe,
determining the phase position of the tooth flanks of the second gear with the second meshing probe;
wherein the shift slide and/or the axial slide may optionally be moved to position the first and/or the second meshing probe;
determining a difference angle between a reference tooth flank of the first gear and a reference tooth flank of the second gear;
determining the gear coupling angle for machining at least one of the gears of the double gear workpiece, taking into account the determined difference angle.

Preferably, the probe axis is perpendicular to the workpiece spindle axis in the measuring position. In addition, the first meshing probe, and possibly also the second meshing probe, are attached to the probe carrier in such a way that the probe axis is perpendicular to the tool spindle axis and preferably intersects it, i.e. runs radially to the tool spindle axis. In order to move from the measuring position to the parking position and vice versa, the probe carrier may be swiveled through a swivel angle of between 45° and 150°, preferably between 60° and 120°.

For even more flexible positioning relative to the workpiece, the first meshing probe and/or, if applicable, the second meshing probe may be mounted on the probe carrier so that it can be moved in parallel to the tool spindle axis.

The first meshing probe and/or, if applicable, the second meshing probe may be manually movable. Alternatively, the probe carrier may comprise a probe drive, which is configured to drive a displacement of the first meshing probe parallel to the tool spindle axis. In particular, the probe drive may comprise a numerically controlled (NC) axis. For example, the probe drive may comprise an electric motor and a threaded spindle, which are arranged on the probe carrier. The probe drive may further be configured to drive the second meshing probe together with the first meshing probe for displacement parallel to the tool spindle axis.

It is also conceivable that the probe carrier comprises a further probe drive of the same type or of a different type than the aforementioned probe drive, wherein the further probe drive only drives a displacement of the second meshing probe parallel to the tool spindle axis, so that a displacement of the first meshing probe and of the second meshing probe parallel to the tool spindle axis may be driven independently of one another.

The advantage of a controlled displaceability of at least one meshing probe lies in particular in the fact that its position along the tool spindle axis can be adapted in a controlled manner to an area of the machining tool that is currently intended for engagement with the workpiece to be machined. Grinding worms in particular may have differently shaped areas along the tool spindle axis for different machining operations, such as roughing, finishing or polishing. By changing the axial position of the meshing probe along the tool spindle axis relative to the grinding worm, travel distances of the grinding worm between meshing and subsequent workpiece machining can be minimized. For example, during the meshing operation, the grinding worm may already be in a grinding position with respect to the shift direction in which the workpiece is subsequently machined. This allows the meshing operation and, if necessary, other measurements carried out with the meshing probe (e.g. pitch or concentricity measurements) to be carried out particularly accurately and with short non-productive times.

It is also conceivable that the first meshing probe and/or, if applicable, the second meshing probe may be movable manually or in a driven manner tangentially to a swivel circle defined by the swivel movement of the respective meshing probe. In particular, if the swivel device is in an angular position in which the probe axis of the first and/or the second meshing probe is perpendicular to the workpiece axis, an intersection point of the probe axis with the workpiece axis may be displaced in this way in the axial direction along the workpiece axis independently of a position of the axial slide.

Additionally or alternatively, the probe carrier may comprise a joint that defines a joint axis that runs offset to the tool spindle axis, wherein the first meshing probe and/or, if applicable, the second meshing probe can be swiveled about the joint axis, whereby a position of the probe axis of the first meshing probe and/or, if applicable, the second meshing probe can be adjusted independently of an angular position of the swivel device. The joint axis may run parallelly or perpendicularly to the tool spindle axis.

The swivel device may comprise a first bearing structure, wherein the probe carrier is mounted on the first bearing structure so that it can swivel about the tool spindle axis. In particular, the bearing structure may have a rolling bearing device, wherein the rolling bearing device may comprise, for example, an angular contact ball bearing, in particular an angular contact ball bearing pair, or a crossed roller bearing.

The machining tool preferably has:
a proximal tool end and a distal tool end, which is axially opposite the proximal tool end along the tool spindle axis,
wherein the tool spindle may be configured to drive the machining tool from the proximal tool end.

The first bearing structure may be arranged proximally to the proximal end of the tool.

In particular, the tool spindle may comprise a drive motor for rotationally driving the machining tool, with the drive motor preferably driving a tool spindle shaft to rotate about the tool spindle axis.

The tool spindle may comprise a drive motor housing in which the drive motor is arranged.

The first bearing structure may be arranged axially along the tool spindle axis between the drive motor and the machining tool. In particular, the first bearing structure may be attached to a tool spindle bearing flange of the tool spindle, wherein the tool spindle bearing flange has an opening for receiving the tool spindle shaft and is preferably rigidly attached to the drive motor housing.

Alternatively, the first bearing structure may be arranged distally to the distal end of the tool. In such a case, the first bearing structure may be permanently attached to the shift slide, for example.

In certain embodiments, the probe carrier may comprise a probe carrier arm which extends radially from the tool spindle axis, preferably beyond a maximum radius of the machining tool. In particular, the probe carrier may have a carrier body which is arranged concentrically to the tool spindle axis and from which the probe carrier arm extends radially outwards. The carrier body and the probe carrier arm may be made from a single piece or be detachably connected to each other. The first meshing probe and, if applicable, the second meshing probe may be attached to a free-standing end of the probe carrier arm.

In certain embodiments, the probe carrier can comprise a probe carrier arm which is “L-shaped”, i.e. the probe carrier arm can comprise a first section which extends radially with respect to the tool spindle axis, preferably beyond a maximum radius of the machining tool, and a second section which adjoins the first section and extends parallel to the tool spindle axis, preferably along the machining tool. The first and/or, if applicable, the second meshing probe can be arranged along the second section of the probe carrier arm.

In an embodiment in which the first bearing structure is arranged distally from the distal tool end, the swivel device may further comprise a second bearing structure, wherein the probe carrier is additionally also swivelably mounted on the second bearing structure, wherein the second bearing structure is arranged axially along the tool spindle axis between the tool spindle and the machining tool, and wherein the probe carrier extends from the proximal tool end to the distal tool end.

In particular, in such an embodiment, the sensor support may be “U-shaped”, i.e. the aforementioned probe carrier arm may comprise, in addition to the first and second sections, a third section which adjoins the second section and extends in parallel to the first section, i.e. radially to the tool spindle axis. The third section of the probe carrier arm may be swivelably mounted on the second bearing structure, while the first section is swivelably mounted on the first bearing structure and the second section extends along the machining tool, so that the probe carrier arm embraces the machining tool like a bracket. The second section may be connected to the first section and/or the third section in a detachable manner, for example via a hook connection, a latching connection, a screw connection or a magnetic connection, whereby the bracket-like probe carrier arm may be opened to facilitate replacement of the machining tool.

Irrespective of the presence of a second bearing structure, the first bearing structure may have a protective wall, particularly if it is arranged distally from the distal end of the tool. In such a case, the protective wall is preferably arranged at the distal tool end distally to the probe carrier and preferably extends in a plane perpendicular to the tool spindle axis.

To ensure repeatability and precision of the measuring position, the swivel device may have a measuring position stop against which the probe carrier stops in the measuring position.

The measuring position stop may be arranged between the distal tool end and the protective wall, wherein the protective wall preferably extends radially with respect to the tool spindle axis in such a way that the measuring position stop is covered by the protective wall when viewed along the tool spindle axis in direction of the proximal tool end, and wherein the measuring position stop is preferably covered by the probe carrier, in particular by the carrier body of the probe carrier, when viewed from the proximal tool end along the tool spindle axis. In particular, the measuring position stop may be attached to an inner side of the protective wall facing the probe carrier.

This allows the measuring position stop to be protected from contamination that may for example occur during the machining process of the workpiece.

Alternatively or additionally, a region of the measuring position stop may be pressurized with compressed air to prevent the ingress of impurities and, preferably, to remove any impurities from the stop surfaces of the measuring position stop at the same time.

Preferably, the swivel device comprises a swivel device drive, which is configured to swivel the probe carrier between the measuring position and the parking position.

If a protective wall as described above is present, the swivel device drive may be arranged on a side of the protective wall facing away from the probe carrier and may be connected to the probe carrier through the protective wall, for example by means of a connecting pin extending through an arcuate slot in the protective wall. Alternatively, the swivel device drive can also be located on a side of the protective wall facing the probe carrier.

The swivel device drive may comprise a linear drive which has a drive element connected to the probe carrier, wherein the drive element may be linearly extendable in a plane perpendicular to the tool spindle axis tangentially to a swivel circle which is concentric to the tool spindle axis, and wherein the linear drive is mounted so as to be rotatable about a bearing axis running in parallel to the tool spindle axis.

The parking position can be defined by an end position of the linear actuator in which the drive element is either fully extended or fully retracted, i.e. retracted.

The linear drive can, for example, be an electric motor drive, a hydraulic drive or a pneumatic drive. The drive element can be a piston rod, for example.

Alternatively, the swivel device drive may comprise a rotary motor (i.e. a motor for generating a rotary motion), wherein the rotary motor has a driven motor shaft which cooperates with the probe carrier and preferably extends parallel to the tool spindle axis. The motor shaft defines an axis of rotation of the rotary motor, whereby the axis of rotation can either coincide with the tool spindle axis or be arranged offset to the tool spindle axis. In particular, the rotary motor can be an electric motor, a hydraulic motor or a pneumatic motor. Particularly in cases in which the machine tool comprises a balancing device which is arranged coaxially to the tool spindle axis for balancing the machining tool at the distal end of the tool, it can be advantageous if the rotational axis of the swivel drive is arranged offset to the tool spindle axis so as not to get in the way of the balancing device. In order to nevertheless achieve a swiveling of the first and/or possibly second meshing probe around the tool spindle axis, a transmission structure such as a spur gear or toothed belt stage can also be provided to transmit a rotation of the motor shaft to the probe carrier.

The parking position may be defined by a predetermined, controlled rotary position of the motor shaft in the case of a swivel device drive with a rotary motor.

Regardless of the type of swivel device drive, the parking position may alternatively be defined by a mechanical parking position stop. It is also conceivable that the measuring position is defined by a predefined, controlled position of the swivel device drive, in particular the drive element of the linear drive or the motor shaft of the rotary motor.

### BRIEF DESCRIPTION OF THE DRAWINGS

Preferred embodiments of the invention are described below with reference to the drawings, which are for explanatory purposes only and are not to be interpreted restrictively. In the drawings:

FIG. 1 shows a schematic perspective view of a machine tool according to a first embodiment with the meshing probe in the measuring position;

FIG. 2 shows an enlarged view of the section E1 marked in FIG. 1;

FIG. 3 shows the embodiment shown in FIG. 1 with the meshing probe in the parking position;

FIG. 4 shows an enlarged view of the section E3 marked in FIG. 3;

FIG. 5 shows a perspective view of a section of the machine tool comprising the tool spindle and the swivel device according to a modification of the first embodiment;

FIG. 6A shows a front view of the components shown in FIG. 5;

FIG. 6B shows a first sectional view in the central longitudinal sectional plane V-V marked in FIG. 6A;

FIG. 6C shows a second sectional view in the cross-sectional plane U-U marked in FIG. 6A;

FIG. 7 shows a schematic perspective view of a machine tool according to a second embodiment with the meshing probe in the measuring position;

FIG. 8 shows an enlarged view of the section E4 marked in FIG. 7;

FIG. 9 shows a schematic perspective view of a machine tool according to a third embodiment with the meshing probe in the measuring position;

FIG. 10 shows an enlarged view of the section E5 marked in FIG. 9;

FIG. 11 shows a perspective view of a section of the machine tool comprising the tool spindle and the swivel device according to a modification of the third embodiment;

FIG. 12A shows a front view of the components shown in FIG. 11;

FIG. 12B shows a sectional view in the central longitudinal sectional plane W-W marked in FIG. 12A;

FIG. 13 shows a schematic perspective view of a machine tool according to a fourth embodiment with the meshing probe in the measuring position;

FIG. 14 shows an enlarged view of the section E6 marked in FIG. 13;

FIG. 15 shows a schematic perspective view of a machine tool according to a fifth embodiment with the meshing probe in the measuring position;

FIG. 16 shows an enlarged view of the section E7 marked in FIG. 15;

FIG. 17 shows a schematic perspective view of a machine tool according to a sixth embodiment with the meshing probe in the measuring position;

FIG. 18 shows an enlarged view of the section E8 marked in FIG. 17;

FIG. 19 a modification of the sixth embodiment in the section E8 marked in FIG. 17 with a probe carrier in a closed state, and

FIG. 20 shows the modification of the sixth embodiment of FIG. 19 with a probe carrier in an open state.

### DESCRIPTION OF PREFERRED EMBODIMENTS

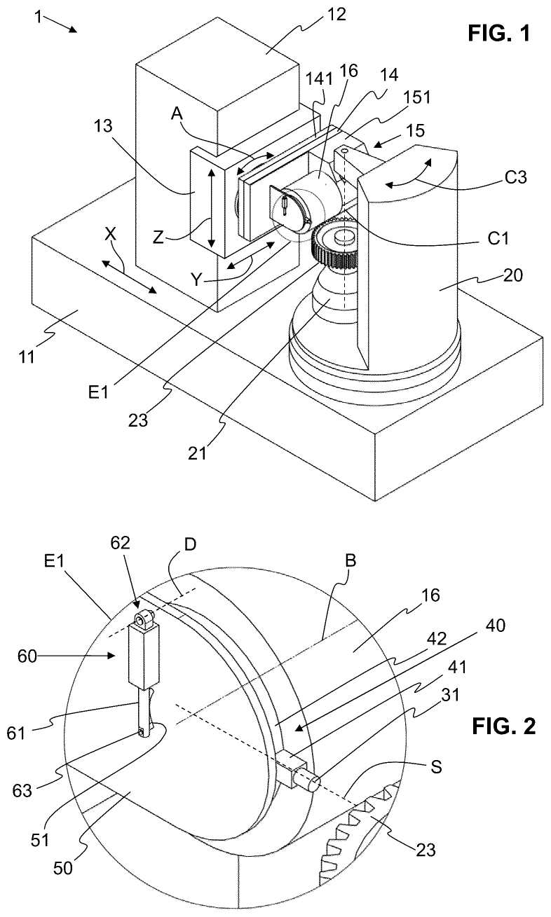

FIGS. 1-20 show machine tools 1 according to various embodiments of the invention. In the following, those features of the machine tool 1 which occur in all the embodiments shown are explained first.

### General Structure of the Machine Tool

The machine has a machine bed 11 on which a tool carrier 12 is guided in a displaceable manner along a radial infeed direction X. A tool spindle 15, which defines a tool spindle axis B, is arranged on the tool carrier. The tool spindle comprises a drive motor housing 151, in which a drive motor 1512 is arranged, and a tool spindle shaft 152, which is rotatable in the drive motor housing 151 about the tool spindle axis B and is driven by the drive motor 1512. A machining tool in the form of a worm-shaped profiled grinding wheel (grinding worm) 16 is mounted on the tool spindle 15. The grinding worm 16 is driven by the drive motor 1512 to rotate about a tool spindle axis B. The tool spindle 15 with the clamped grinding worm 16 is displaceable along a shift direction Y relative to the tool carrier 12. In order to move the tool spindle 15 along the shift direction Y, a shift slide 14 is provided on which the tool spindle 15 is arranged. The tool spindle 15 with the clamped grinding worm 16 is further displaceable along a feed direction Z relative to the tool carrier. In order to move the tool spindle 15 along the feed direction Z, an axial slide 13 is provided, on which the shift slide 14 and thus the tool spindle 15 is arranged.

To enable adaptation to the helix angle of the gear to be machined, the shift slide and thus the tool spindle 15 arranged on it can be swiveled about a swivel axis (the so-called A-axis) running in parallel to the X-axis. A swivel body 141 is used for this purpose, which can swivel about the A-axis relative to the axial slide and on which the shift slide 14 is arranged for linear displacement.

The machine bed 11 also carries a workpiece carrier 20, which can be designed as a rotary turret that can be swiveled about an axis C3 between two or more positions. A workpiece spindle 21 is arranged on the workpiece carrier. A workpiece 23 can be clamped on the workpiece spindle 21 and driven to rotate about a workpiece spindle axis C1. The workpiece spindle 21 visible in FIGS. 1, 3, 7, 9, 13, 15 and 17 is in a machining position in which the workpiece 23 can be machined with the grinding worm 16. In order to clamp a still unmachined workpiece (blank), preferably by an automatic workpiece changer (not shown), the workpiece carrier 20 can be swiveled about the axis C3 into a workpiece changing position.

When the new workpiece to be machined is clamped, a meshing operation is performed. For this purpose, the workpiece spindle 21 is set in rotation and the position of the tooth gaps of the workpiece 23 is measured using a non-contacting meshing probe 31. The gear coupling angle is determined on the basis of this measurement.

The machine tool 1 has a swivel device which is arranged on the tool carrier 12. The swivel device comprises a probe carrier 40, to which the meshing probe 31 is attached. The swivel device is configured to swivel the meshing probe 31 about the tool spindle axis B between a measuring position, in which the meshing operation is performed, and a parking position, in which the meshing probe 31 is located during the machining of the workpiece 23.

If the workpiece spindle 21, which carries the workpiece 23 to be machined, is in the machining position, the workpiece 23 is brought into collision-free engagement with the grinding worm 16 by moving the tool carrier 12 along the X-axis. The workpiece 23 is now machined by the grinding worm 16 in generating engagement. This is carried out by one or more machining strokes, for example one or more roughing strokes, followed by one or more finishing strokes. Optionally, one or more polishing strokes may follow. During each machining stroke, the grinding worm 16 is continuously advanced along the Z-axis relative to the workpiece 23 with a constant or variable radial X-feed (so-called axial stroke). At the same time, the tool spindle 15 is displaced continuously or gradually along the shift axis Y in order to allow unused areas of the grinding worm 16 to be used during machining (so-called shift movement).

### First Embodiment

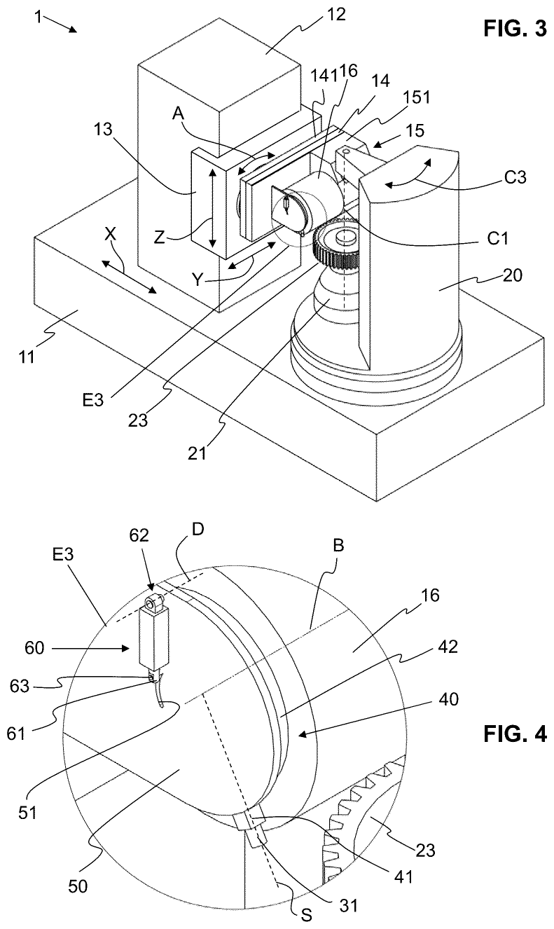

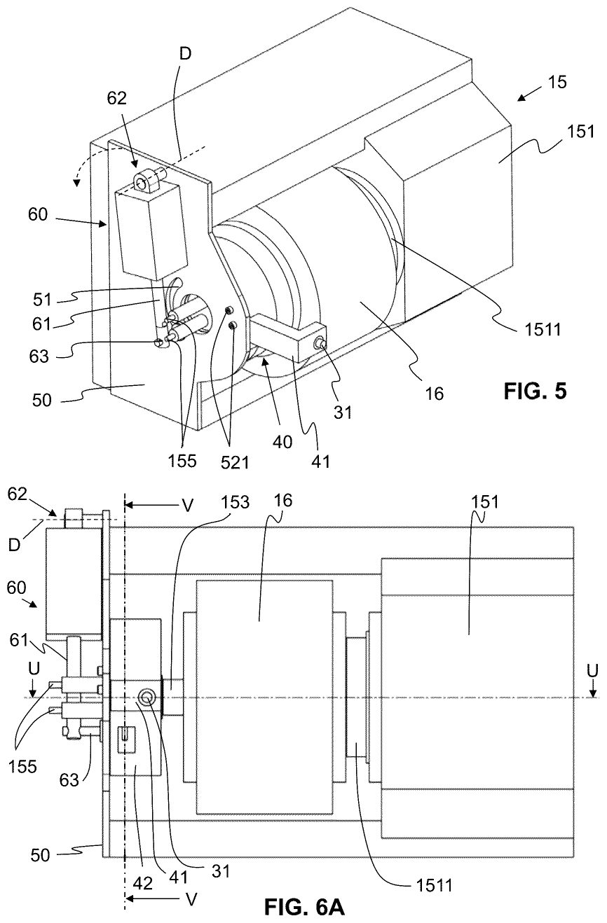

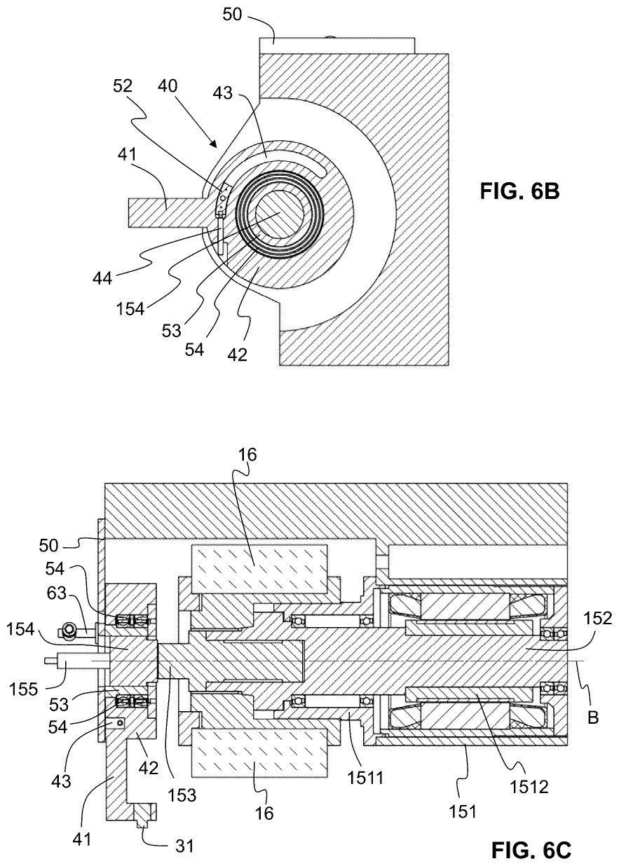

FIGS. 1-4 schematically illustrate a machine tool 1 for machining the tooth flanks of pre-toothed workpieces according to a first embodiment of the invention. FIGS. 1 and 3 each show a simplified perspective view of the machine tool 1. FIGS. 2 and 4 each show enlarged views of the cut-outs marked in FIGS. 1 and 3. FIG. 5 shows a perspective view of a section of the machine tool 1 comprising the shift slide 14, the tool spindle 15 and the swivel device with the probe carrier 40 and the meshing probe 31 according to a modification of the first embodiment. FIG. 6A shows a front view of the components shown in FIG. 5, FIG. 6B shows a first sectional view in the central longitudinal sectional plane V-V marked in FIG. 6A, and FIG. 6C shows a second sectional view in the cross-sectional plane U-U marked in FIG. 6A.

FIG. 2 shows an enlarged view of the section E1 marked in FIG. 1, in which the meshing probe 31 can be seen in the measuring position. The meshing probe 31 has a probe axis S, which defines a measuring direction. In the measuring position, the probe axis S is preferably perpendicular to the workpiece spindle axis C1.

The machining tool, in the example shown the grinding worm 16, has a proximal tool end, which faces the tool spindle 15, and a distal tool end, which is located axially opposite the proximal tool end along the tool spindle axis B. The swivel device has a bearing structure which is attached to the shift slide 14 and on which the probe carrier 40 is swivelably mounted.

In this first embodiment, the bearing structure is arranged distally from the distal end of the tool and comprises a protective wall 50, which extends in a plane perpendicular to the tool spindle axis B. The probe carrier 40 and the meshing probe 31 are located axially between the distal tool end and the protective wall 50. The protective wall 50 is attached to the shift slide 14. To enable a replacement of the grinding worm 16, the protective wall 50 is preferably swivelably or removably attached to the shift slide 14.

In the first embodiment shown here, the probe carrier 40 has a probe carrier arm 41 which extends radially away from the tool spindle axis B, wherein the meshing probe 31 is located at the free-standing end of the probe carrier arm 41 and projects radially beyond a maximum radius of the grinding worm 16 so that the meshing probe 31 can be positioned close enough to the workpiece 23 for the meshing measurement without the grinding worm 16 colliding with the workpiece 23. As shown in FIG. 5, in a modification of the first embodiment, the probe carrier arm 41 may be angled at its free-standing end.

In this first embodiment, the swivel device drive, which is configured to swivel the probe carrier 40 from the measuring position into the parking position and vice versa, comprises a linear drive 60, which is arranged on a side of the protective wall 50 facing away from the probe carrier 40. The linear drive 60 comprises a drive element 61 in the form of a piston rod, which can be extended linearly in a plane parallel to the protective wall 50. The drive element 61 is connected to the probe carrier 40 via a connecting pin 63, which extends in parallel to the tool spindle axis B through a slot 51 in the protective wall 50. The slot 51 is arc-shaped and corresponds to an arc segment of a circle which is arranged concentrically to the tool spindle axis B.

At an end opposite the drive element 61, the linear drive 60 has a swivel bearing 62, which defines a bearing axis D around which the linear drive 60 is rotatable, whereby the bearing axis D runs in parallel but offset to the tool spindle axis. The drive element 61 is retracted or extended to swivel the probe carrier 40. The drive element performs a movement with a movement component in a tangential direction, whereby the term “tangential direction” in this context refers to a swivel circle that is defined by the swivel movement of the probe carrier. The connecting pin 63, which is connected to the drive element, is guided along the arcuate slot 51, which leads to a swiveling of the linear drive 60 about the bearing axis D and at the same time to a swiveling of the probe carrier 40 about the tool spindle axis B. The connecting pin 63 can be rotatably connected to the drive element and rigidly connected to the probe carrier, or it can be rigidly connected to the drive element and rotatably connected to the probe carrier.

In FIG. 3, the machine tool 1 is shown in a state in which the meshing probe 31 is in a parking position. FIG. 4 shows an enlarged view of the section E3 marked in FIG. 3, in which the parking position can be seen in an enlarged manner. In the first embodiment shown here, the parking position is defined by an end position of the linear drive 60, in which the drive element 61 is retracted (pulled back) to the maximum. In this parking position, the meshing probe 31 is directed downwards, i.e. in direction of the machine bed 11.

The linear drive may for example be formed by an electric, hydraulic or pneumatic cylinder.

FIG. 5 shows a more detailed and enlarged perspective view of the swivel device and the tool spindle 15, wherein the tool spindle 15 comprises a balancing device which is not visible in FIGS. 1-4. The balancing device comprises a balancing head 153, visible in FIGS. 6A and 6C, which is located substantially within the tool spindle shaft 152, and a communication module 154 for transmitting and/or receiving signals to and from the balancing head 153. In the embodiment shown here, the communication module 154 is attached to the protective wall 50, wherein the protective wall 50 comprises a through hole for connections 155 of the communication module. As indicated by a dashed arrow in FIG. 5, the protective wall be pivotable to make it easier to replace the grinding worm 16.

FIG. 6B shows a sectional view of the swivel device, which has a mechanical measuring position stop 52, which is arranged on a side of the protective wall 50 facing the grinding worm 16 and is fastened to the protective wall 50 with screws 521 (see FIG. 5) projecting through the protective wall 50. The probe carrier 40 comprises a hollow cylindrical carrier body 42, from which the probe carrier arm 41 projects radially outwards. The probe carrier arm 41 may be made in one piece with the carrier body. A bearing bush 53, which is attached to the protective wall 50, is arranged concentrically inside the carrier body 42. An annular rolling bearing device is arranged between the bearing bush 53 and the carrier body 42, wherein the rolling bearing device, as shown in FIG. 6C, may in particular comprise two axially adjacent, annular angular contact ball bearings 54. On its side facing the protective wall 50, the carrier body 42 has an arcuate groove 43 arranged concentrically with respect to the tool spindle axis, in which the measuring position stop 52 is arranged. A stop screw 44 may be screwed into the carrier body 42 tangentially to the tool spindle axis, with which the measuring position can be adjusted with respect to its angular position, preferably in such a way that the probe axis S is perpendicular to the workpiece spindle axis C1. The stop screw 44 is fixed after adjustment. In the measuring position, the stop screw 44 abuts against the measuring position stop 52 along a first swivel direction, which leads to a defined and repeatable angular position of the meshing probe 31 mounted on the probe carrier 40.

In order to ensure precision, the measuring position stop 52 and the stop screw 44 should be protected from contamination, which can occur in particular during machining of the workpiece 23. The protective wall 50 thus advantageously extends radially with respect to the tool spindle axis B in such a way that the measuring position stop 52, viewed along the tool spindle axis B in the direction of the tool spindle 15, is covered by the protective wall 50. In the embodiment shown here, the measuring position stop 52 is covered by the carrier body 42 of the probe carrier 40 when viewed from the other side, i.e. when viewed from the tool spindle along the tool spindle axis. In addition, the region of the measuring position stop 52 may be pressurized with compressed air in order to prevent the ingress of contamination and, in a preferred embodiment, to simultaneously remove any contamination from the stop surfaces.

### Second Embodiment

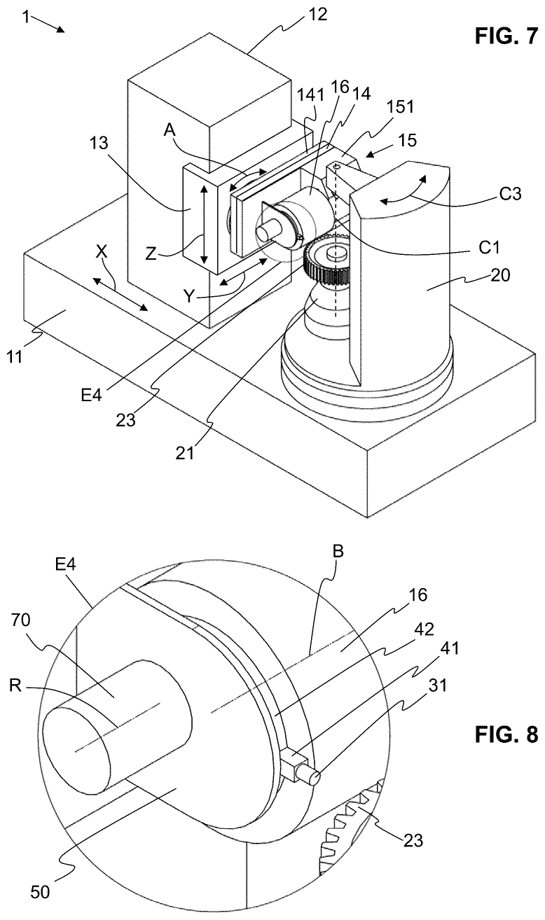

FIGS. 7 and 8 schematically illustrate a machine tool 1 for machining the tooth flanks of pre-toothed workpieces according to a second embodiment of the invention, with FIG. 8 showing an enlarged view of the section E4 marked in FIG. 7.

This second embodiment differs from the first embodiment described above only in that the swivel drive comprises a rotary motor 70 instead of a linear drive. Descriptions of features given in the context of the first embodiment, which have the same reference characters in FIGS. 7 and 8 as in FIGS. 1 and 2, apply analogously to the second embodiment. The rotary motor 70 has a motor shaft which interacts with the probe carrier 40 through the protective wall 50 and runs in parallel to the tool spindle axis B. In the second embodiment shown here, the axis of rotation R of the motor shaft is offset from the tool spindle axis B. Such an offset may be necessary if, as shown in FIGS. 5-6C, a balancing device for the grinding worm 16 is additionally mounted concentrically to the tool spindle axis B at the distal end of the grinding worm 16. In order to nevertheless generate a swiveling of the probe carrier about the tool spindle axis B with a rotary motor 70 arranged offset to the tool spindle axis B, a transmission structure, such as a spur gear or toothed belt stage (not visible in FIGS. 7 and 8), is located on the side of the protective wall 50 facing away from the rotary motor 70 for transmitting the rotation of the motor shaft to the probe carrier 40. In a variant (not shown), however, it would also be conceivable to arrange the rotary motor in such a way that the axis of rotation of the motor shaft coincides with the tool spindle axis B, whereby a transmission structure may not be necessary.

In this second embodiment, a mechanical measuring position stop may also be provided to define the measuring position as described above, while the parking position may be given by a predefined, controlled rotary position of the motor shaft.

### Third Embodiment

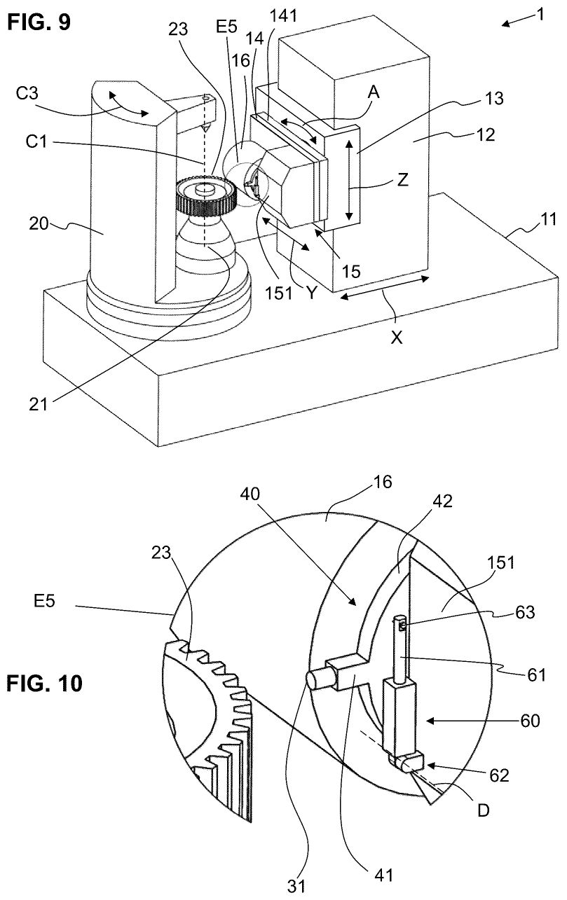

FIGS. 9 and 10 schematically illustrate a machine tool 1 for machining the tooth flanks of pre-toothed workpieces according to a third embodiment of the invention, with FIG. 10 showing an enlarged view of the section E5 marked in FIG. 9.

The third embodiment differs from the first embodiment described above in that the bearing structure, on which the probe carrier 40 with the meshing probe 31 is swivelably mounted, is located proximally from the proximal end of the grinding worm 16 between the grinding worm 16 and the drive motor housing 151. In particular, the bearing structure may be attached directly to the drive motor housing 151 or to a tool spindle bearing flange 1511 of the tool spindle 15.

Analogous to the first embodiment, the swivel device of the embodiment shown in FIGS. 9 and 10 also has a linear drive 60, which is connected to the probe carrier 40. In this third embodiment, however, the swivel bearing 62 of the linear drive 60 is attached directly to the drive motor housing 151, as shown in FIGS. 9 and 10.

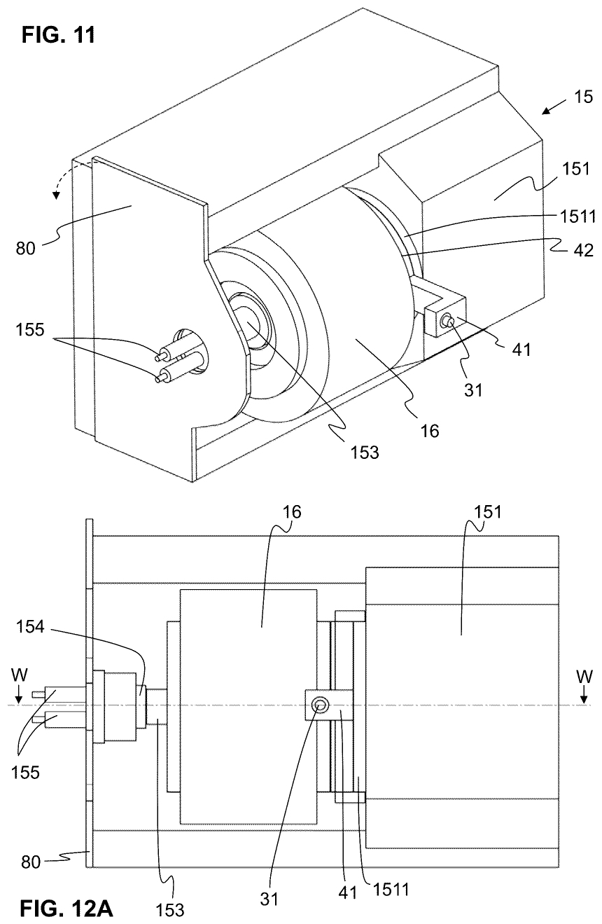

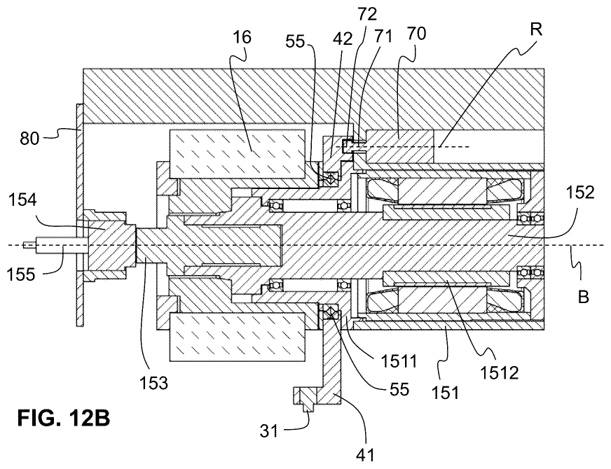

FIGS. 11-12B show a modification of the third embodiment, in which a rotary motor 70 is used instead of a linear drive, and in which the tool spindle 15 has a balancing device, as described above in connection with the second embodiment.

FIG. 11 shows a perspective view of a section of the machine tool comprising the tool spindle 15 and the swivel device with the probe carrier 40 and the meshing probe 31. FIG. 12A shows a front view of the components shown in FIG. 11 and FIG. 12B shows a sectional view in the central longitudinal sectional plane W-W marked in FIG. 12A.

FIGS. 11-12B show a support wall 80 which is arranged distally from the distal end of the grinding worm 16. In the present embodiment, this support wall 80 serves as a support structure for the communication module 154 of the balancing device and, in contrast to the protective wall 50 in FIGS. 5-6C, is not part of the swivel device for the meshing probe. In the embodiment shown in FIGS. 11-12B, the bearing structure of the swivel device is arranged on the tool spindle bearing flange 1511, wherein the tool spindle bearing flange 1511 is fixedly attached to the drive motor housing 151 and has an opening for receiving the rotating tool spindle shaft 152. The probe carrier 40 comprises a carrier body 42, from which the probe carrier arm 41 projects radially outwards. The bearing structure comprises an annular roller bearing device, wherein the roller bearing device comprises in particular a crossed roller bearing 55, which is arranged radially between the tool spindle bearing flange 1511 and the carrier body 42, such that the carrier body 42 is swivelable with the probe carrier arm 41 relative to the stationary tool spindle bearing flange 1511. To drive the swiveling movement, a rotary motor 70 is provided, which has a motor shaft 71 that is connected to the carrier body 42 of the probe carrier 40 via a transmission structure 72, in particular a gear stage.

### Fourth Embodiment

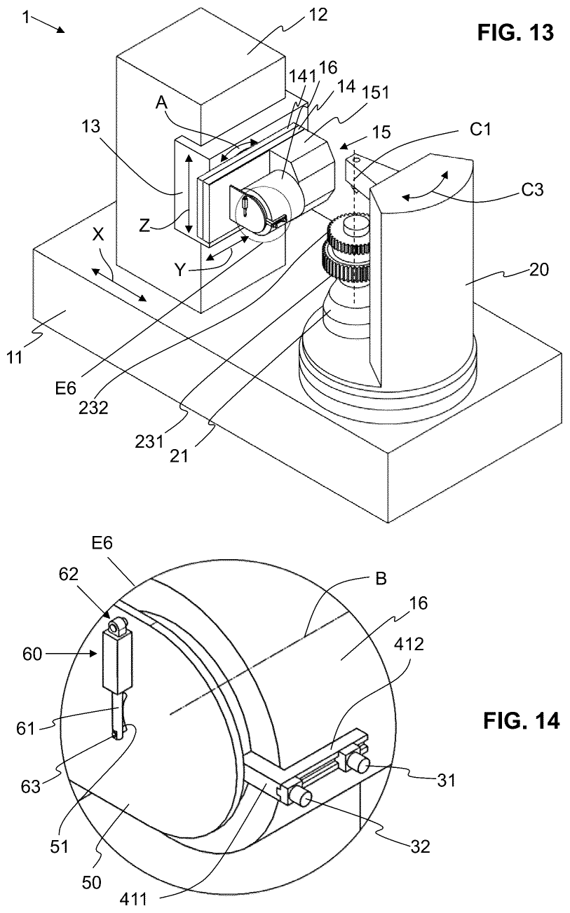

FIGS. 13 and 14 schematically illustrate a machine tool 1 for machining the tooth flanks of pre-toothed workpieces according to a fourth embodiment of the invention, with FIG. 14 showing an enlarged view of the section E6 marked in FIG. 13.

The fourth embodiment differs from the first embodiment described above in that the probe carrier arm 41 is “L-shaped”, i.e. has a first section 411 extending radially with respect to the tool spindle axis B and a second section 412 extending axially parallel to the tool spindle axis B, and in that a second meshing probe 32 is arranged on the probe carrier arm 41. The first meshing probe 31 and the second meshing probe 32 are arranged next to one another on the second section 412 of the probe carrier arm 41, wherein the first meshing probe 31 and/or the second meshing probe 32 can be moved manually along the tool spindle axis B.

The use of a second meshing probe 32 offers advantages for workpieces 23 which have a double gear, i.e. a first gear 231 and a second gear 232, which, as shown in FIG. 13, are arranged concentrically one above the other along the workpiece spindle axis C1. The use of a second meshing probe is particularly advantageous if the first gear 231 has a module that differs from the module of the second gear 232.

### Fifth Embodiment

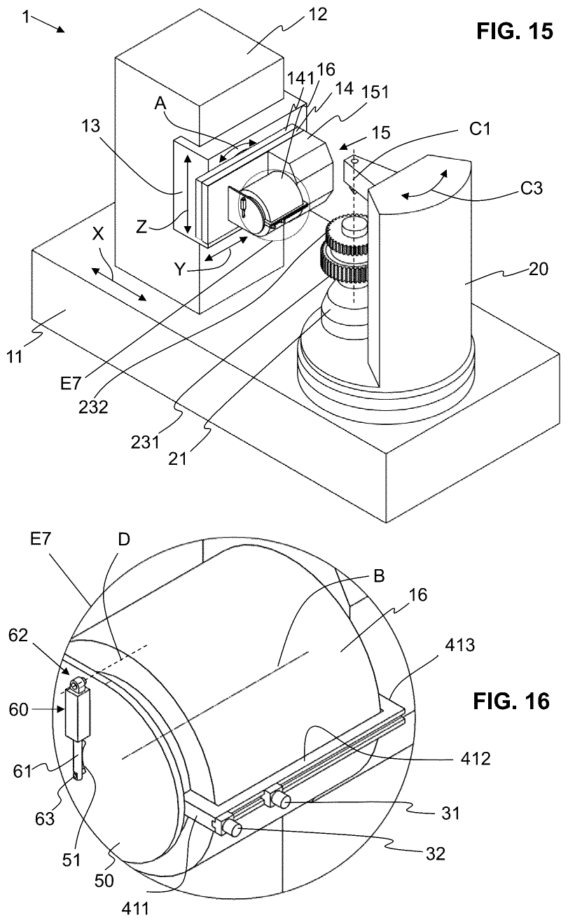

FIGS. 15 and 16 schematically illustrate a machine tool 1 for machining the tooth flanks of pre-toothed workpieces according to a fifth embodiment of the invention, with FIG. 16 showing an enlarged view of the section E7 marked in FIG. 15.

The fifth embodiment differs from the first embodiment described above in that the probe carrier arm 41 is “U-shaped”, i.e. has a first section 411 extending radially with respect to the tool spindle axis B, a second section 412 extending axially parallel to the tool spindle axis B, and a third section 413 extending radially with respect to the tool spindle axis B, and in that a second meshing probe 32 is arranged on the probe carrier arm 41. The first meshing probe 31 and the second meshing probe 32 are arranged next to each other on the second section 412 of the probe carrier arm 41, wherein the first meshing probe 31 and/or the second meshing probe 32 can be moved manually along the tool spindle axis B. In this fifth embodiment, the probe carrier arm 41 forms a bracket which spans the grinding worm 16, as the second section 412 extends from the proximal end to the distal end of the grinding worm 16. The swivel device comprises a first bearing structure with a protective wall 50, which is arranged distally from the distal end of the grinding worm 16, analogously to the first, second and fourth embodiments described above. Furthermore, in this fifth embodiment, the swivel device has a second bearing structure on which the third section of the probe carrier arm 413 is rotatably mounted and which is located between the proximal end of the grinding worm 16 and the drive motor housing 151. The second bearing structure may, for example, be configured analogously to the bearing structure shown in FIG. 12B, i.e. in particular be arranged on the tool spindle bearing flange 1511 and have a rolling bearing extending annularly around the tool spindle bearing flange 1511. In this fifth embodiment, the swivel device drive is arranged distally from the protective wall 50, as described for the first embodiment, and is connected to the probe carrier 40 through the protective wall 50.

### Sixth Embodiment

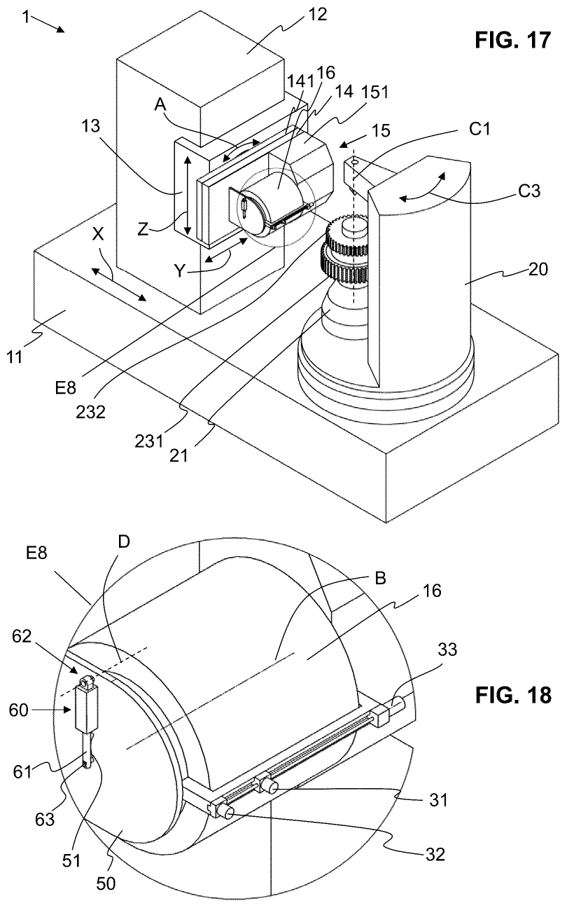

FIGS. 17 and 18 schematically illustrate a machine tool 1 for machining the tooth flanks of pre-toothed workpieces according to a sixth embodiment of the invention, with FIG. 18 showing an enlarged view of the section E8 marked in FIG. 17.

The sixth embodiment differs from the fifth embodiment described above only in that a probe drive 33 is arranged on the probe carrier arm 41, specifically on the third section 413 of the probe carrier arm 41, which drives the first meshing probe 31 to carry out a displacement parallel to the tool spindle axis B along the second section 412 of the probe carrier arm 41 (instead of a manual displacement).

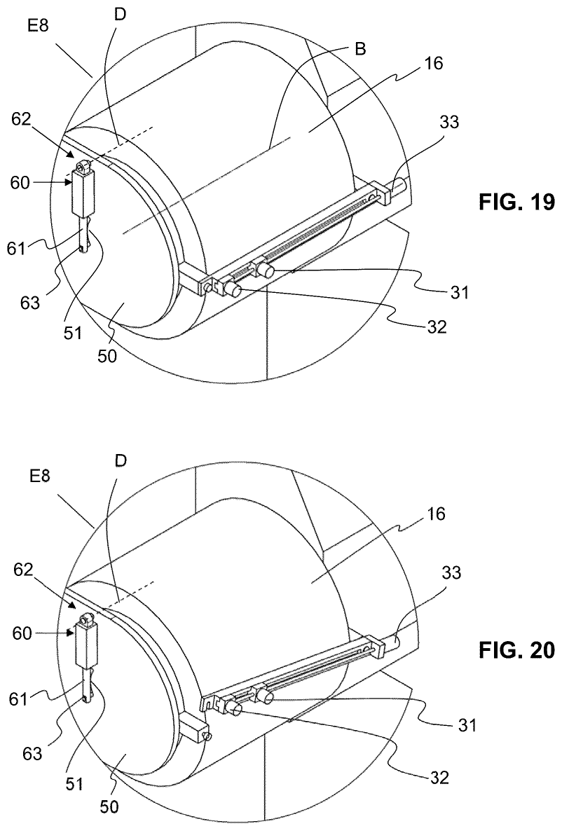

FIGS. 19 and 20 show a modification of the sixth embodiment, in which the second section 412 of the probe carrier arm 41 can be detached from the first section 411 in order to open the bracket and thus, for example, facilitate replacement of the grinding worm. In particular, the second section 412, as shown in FIG. 20, may be swivelable about an axis running in parallel to the third section 413 and can be hooked onto the first section 411 via a hook connection. Alternatively, the first section 411 and the second section 412 may be detachably connected to each other, for example via a snap-in connection, via a plug-in connection, via a screw connection or via a magnetic connection. Furthermore, there may also be a detachable connection between the second section 412 and the third section 413 (not shown).

### Further Variations

Of course, many variations of the embodiments shown are possible, and the invention is not limited to these embodiments.

In particular, the machining tool may also be a profile grinding wheel, a gear hob or a disk cutter.

### LIST OF REFERENCE SYMBOLS

1 machine tool
11 machine bed
12 tool carrier
13 axial slide
14 shift slide
141 swivel body
15 tool spindle
151 drive motor housing
1511 tool spindle bearing flange
1512 drive motor
152 tool spindle shaft
153 balancing head
154 communication module
155 connections
16 grinding worm
20 workpiece carrier
21 workpiece spindle
23 workpiece
31 first meshing probe
32 second meshing probe
33 probe drive
40 probe carrier
41 probe carrier arm
411 first section
412 second section
413 third section
42 carrier body
43 groove
44 stop screw
50 protective wall
51 slot
52 measuring position stop
521 screws
53 bearing bush
54 angular contact ball bearing
55 cross roller bearing
60 linear drive
61 drive element
62 swivel bearing
63 connecting pin
70 rotary motor
71 motor shaft
72 transmission structure
80 support wall
A swivel axis
B tool spindle axis
C1 workpiece spindle axis
D bearing axis
S probe axis
R axis of rotation
X infeed direction
Y shift direction
Z axial direction

1. A machine tool for machining pre-toothed workpieces comprising:
a tool carrier on which a tool spindle is arranged for rotationally driving a machining tool about a tool spindle axis;
a workpiece carrier on which a workpiece spindle is arranged for rotationally driving a pre-toothed workpiece to be machined about a workpiece spindle axis
an axial slide guided on the tool carrier, which is displaceable relative to the workpiece carrier in an axial direction parallel to the workpiece spindle axis
a shift slide which is arranged on the axial slide and which is displaceable parallelly to the tool spindle axis relative to the workpiece carrier,
a first non-contacting meshing probe which is configured to determine a phase position of teeth of the workpiece when the workpiece rotates about the workpiece spindle axis
wherein the meshing probe defines a probe axis which corresponds to a measuring direction of the meshing probe and
a swivel device, wherein the swivel device comprises a probe carrier that can be swiveled, to which the first meshing probe is attached in order to swivel the first meshing probe between a measuring position and a parking position,
wherein the first meshing probe is fastened to the probe carrier such that the probe axis is perpendicular to the tool spindle axis
wherein the tool spindle and the swivel device are arranged on the shift slide and
wherein the swivel device is configured to swivel the first meshing probe about the tool spindle axis.

2. The machine tool of claim 1,
wherein the first meshing probe is mounted on the probe carrier so as to be displaceable parallelly to the tool spindle axis.

3. The machine tool of claim 2, wherein the probe carrier comprises a probe drive which is configured to drive the first meshing probe for displacement parallel to the tool spindle axis.

4. The machine tool of claim 1, further comprising:
a second non-contacting meshing probe which is configured to determine a phase position of teeth of the workpiece when the workpiece rotates about the workpiece spindle axis,
wherein the second meshing probe is mounted on the probe carrier.

5. The machine tool of claim 1, wherein the swivel device comprises a first bearing structure, and
wherein the probe carrier is mounted on the first bearing structure so that the probe carrier can swivel about the tool spindle axis.

6. The machine tool of claim 5, further comprising a machining tool,
wherein the machining tool has:
a proximal tool end and a distal tool end, which is axially opposite the proximal tool end along the tool spindle axis,
wherein the tool spindle is configured to drive the machining tool from the proximal tool end, and
wherein the first bearing structure is arranged proximally to the proximal end of the tool.

7. The machine tool of claim 5, further comprising a machining tool,
wherein the machining tool has:
a proximal tool end and a distal tool end, which is axially opposite the proximal tool end along the tool spindle axis,
wherein the tool spindle is configured to drive the machining tool from the proximal tool end, and
wherein the first bearing structure is arranged distally to the distal end of the tool.

8. The machine tool of claim 7, wherein the swivel device comprises a second bearing structure, wherein the probe carrier is mounted on the second bearing structure so that the probe carrier can swivel,
wherein the second bearing structure is arranged proximally to the proximal end of the tool, and
wherein the probe carrier extends from the proximal end of the tool to the distal end of the tool.

9. The machine tool of claim 7, wherein the first bearing structure comprises a protective wall which is arranged at the distal tool end distally to the probe carrier.

10. The machine tool of claim 1, wherein the swivel device further comprises:
a measuring position stop against which the probe carrier stops in the measuring position.

11. The machine tool of claim 10, wherein the first bearing structure comprises a protective wall which is arranged at the distal tool end distally to the probe carrier, and wherein the measuring position stop is arranged between the distal tool end and the protective wall.

12. The machine tool of claim 1, wherein the swivel device comprises a swivel device drive which is configured to swivel the probe carrier between the measuring position and the parking position.

13. The machine tool of claim 12, wherein the first bearing structure comprises a protective wall which is arranged at the distal tool end distally to the probe carrier, and wherein the swivel device drive is arranged on a side of the protective wall facing away from the probe carrier and is connected to the probe carrier through the protective wall.

14. The machine tool of claim 12, wherein the swivel device drive comprises a linear drive which has a drive element connected to the probe carrier,
wherein the drive element is linearly extendable in a plane perpendicular to the tool spindle axis tangentially to a swivel circle which is concentric to the tool spindle axis, and
wherein the linear drive is mounted so as to be rotatable about a bearing axis extending in parallel to the tool spindle axis.

15. The machine tool of claim 12, wherein the swivel device drive comprises a rotary motor, wherein the rotary motor has a motor shaft which cooperates with the probe carrier and extends in parallel to the tool spindle axis.

16. The machine tool of claim 4,
wherein the second meshing probe is displaceable parallelly to the tool spindle axis.

17. The machine tool of claim 4,
wherein the first meshing probe and the second meshing probe are arranged next to each other in parallel to the tool spindle axis.

18. The machine tool of claim 7, wherein the protective wall extends in a plane perpendicular to the tool spindle axis.

19. The machine tool of claim 10, wherein the first bearing structure comprises a protective wall which is arranged at the distal tool end distally to the probe carrier, and
wherein the protective wall extends radially with respect to the tool spindle axis in such a way that the measuring position stop is covered by the protective wall when viewed along the tool spindle axis in direction of the proximal tool end.

20. The machine tool of claim 10, wherein the first bearing structure comprises a protective wall which is arranged at the distal tool end distally to the probe carrier, and
wherein the measuring position stop, viewed from the proximal tool end along the tool spindle axis, is covered by the probe carrier.
